(19) United States
(12) Patent Application Publication
(10) Pub. No.: US 2004/0073334 A1
(43) Pub. Date: Apr. 15, 2004

(54) Communication system for vended goods

(76) Inventor: Steven N. Terranova, Cary, NC (US)

Correspondence Address: WITHROW & TERRANOVA, P.L.L.C., P.O. BOX 1287, CARY, NC, 27512, US

(21) Appl. No.: 10/267,941

(22) Filed: Oct. 9, 2002

(51) Int. Cl. G06F 17/00

(52) U.S. Cl. 700/236

(57) ABSTRACT

A technique for optimizing space utilization within a retail display case determines velocities with which product is sold from the retail display case by using sensors proximate the dispensing end of the retail display case. The sensors report to a controller within the retail display case which periodically reports to a remote location. The data reported from the retail display case is processed according to an algorithm such that velocities and optimal product configurations may be derived.

### FIELD OF THE INVENTION

The present invention is directed to a system by which retail establishments may predict inventory replacement needs by tracking the velocity of vended items.

### BACKGROUND OF THE INVENTION

Owners of vending machines face a dilemma in that increasing the number of service calls increases the chances that a vending machine will function properly and have adequate inventory at any given time, but at increased costs. The converse, decreasing service calls, reduces costs, but increases the chances of lost revenues through malfunction or out-of-stock conditions.

This dilemma also exists for retail establishments that have coolers of beverages and other impulse purchase consumables. While the risk of malfunction in beverage coolers may perhaps be lower than for vending machines, the velocity with which the product leaves the store necessitating periodic restocking may be just as difficult to estimate.

A challenge thus facing both operators is to find the frequency of service calls that maximizes profits. The vending machine industry found a solution in U.S. Pat. No. 6,181,981, which is hereby incorporated by reference in its entirety. The '981 patent provided a self-monitoring vending machine with remote communication and a process for analyzing information so communicated to provide efficient scheduling of service calls.

Among the principal features of that patent were the electronic monitoring means coupled to monitoring points within the vending machine, which were capable of identifying critical characteristics of the machine's operation, including cash received and numbers of various goods dispensed.

However, a need still remains for a comparable solution for cooler type retail devices and the like.

### SUMMARY OF THE INVENTION

The present invention adapts the teachings of the previously incorporated '981 patent for a convenience store type beverage cooler or other retail display case. In particular, a display case may comprise a plurality of shelves, each with rows of products displayed thereon. A sensor may be placed on the end of each row, so that the sensor may detect when a product is removed from the row. Each time a product is removed, a signal is sent to a control system that keeps a running count of the number of products removed from each of the rows.

The sensors may detect a product passing through a plane or detect a product's proximity by a change in capacitance of a circuit or other sensing technique as needed or desired.

This information may be periodically communicated to a local device through a wired or wireless connection. This information may further be communicated to a remote site. From this information, a flow rate velocity of the product may be determined. The flow rate velocity may be used to determine when service calls are required to replenish inventory or the like. Further, the information may be used to determine an optimal space to sales configuration wherein an optimal number of rows and shelves are devoted to each product such that service call frequency is reduced.

In an alternate embodiment, a sensor may also be placed at the location of the product so as to detect a full capacity condition. Alternatively, the capacity could be stored in a host management system. This may be used to help in determining if a product is completely depleted, to assist in velocity determination, or other use as needed or desired.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a convenience store retail display case according to an exemplary embodiment of the present invention;

FIG. 2 illustrates schematically the electronics of an exemplary embodiment of the present invention;

FIG. 3 illustrates a flow chart for velocity determination; and

FIGS. 4-6 illustrate a flow chart explicating exemplary methodology associated with the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

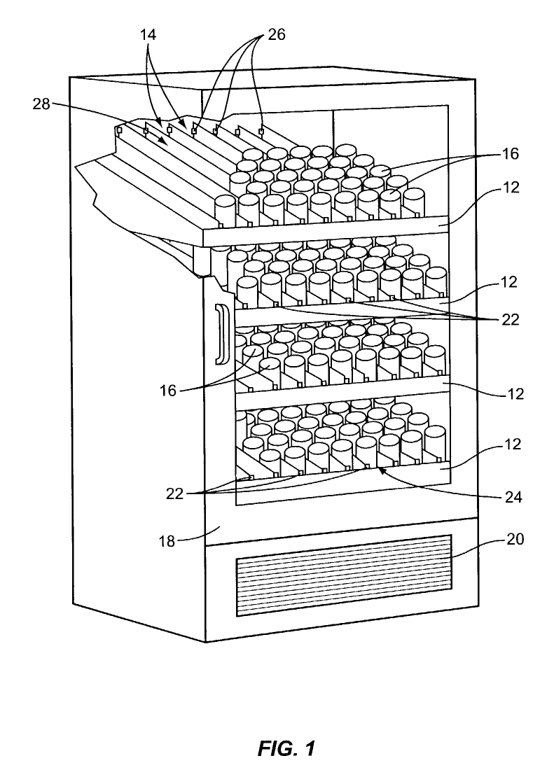

The present invention is an extension of the previously incorporated U.S. Pat. No. 6,181,981 further adapted to help convenience store operators manage retail display cases, such as drink coolers and the like. FIG. 1 illustrates an exemplary drink cooler 10 according to one embodiment of the present invention. The drink cooler 10 may be comparable to those sold by Victory Refrigeration of 110 Woodcrest Road, Cherry Hill, N.J. 08003 under the product designations VM-1 and VM-2, although other retail display cases may also be used with the present invention. The drink cooler 10 may comprise a plurality of shelves 12, each with a plurality of drink holding rows 14. The shelves 12 may be inclined or sloped so that when a drink 16 is removed from a row 14, the remaining drinks 16 slide down. This allows the drink cooler 10 to present a uniform, even front display of drinks 16 to a customer and alleviate the need for the customer to reach deep into the drink cooler 10 to retrieve a drink 16.

As is well understood, the drink cooler 10 may comprise a transparent door 18 and a vent grill 20. Air conditioning machinery (not shown) may be positioned underneath or on top of the drink cooler 10 as is well understood. Other conventional features may be present, but are not shown.

The drink cooler 10 has been modified by the incorporation of sensors 22 positioned at the front end 24 of the rows 14. The sensors 22 detect when a drink 16 is removed from a row 14. Additionally, optional rear sensors 26 may be positioned near the back 28 of the rows 14 to indicate that a given row 14 is full of drinks 16. A sensor 22 may also detect when no drinks 16 are present within a row 14.

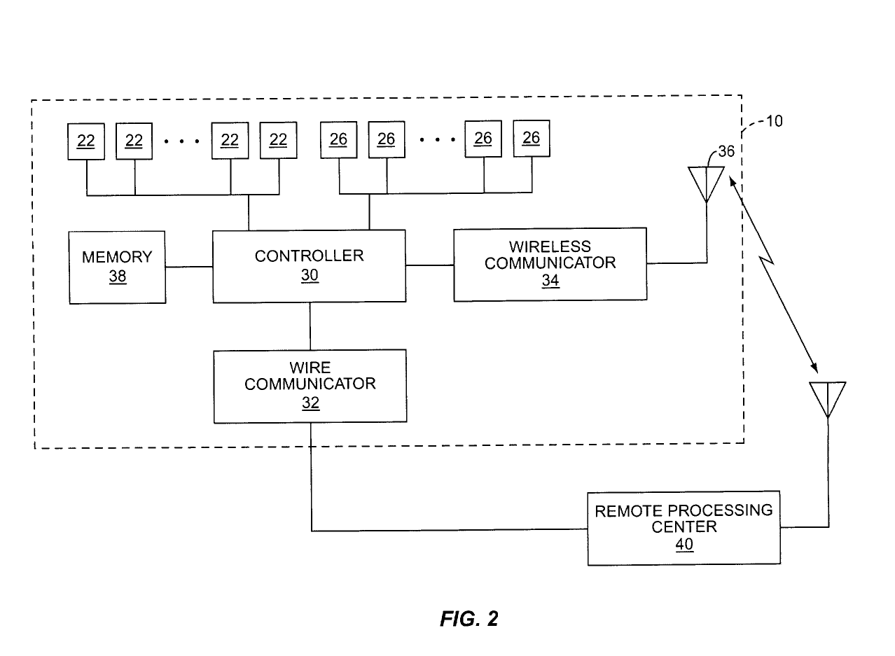

The sensors 22, 26 may be of any appropriate sort, such as optical sensors, RF sensors, and/or proximity sensors. For example, a light emitting diode and a photo sensor may be positioned on opposite sides of a row 14. Each time the path of the light from the light emitting diode to the photo sensor is interrupted, a controller 30 (FIG. 2) may infer that a product has been removed. Alternatively, the light emitting diode and photo sensor may be positioned such that a product naturally interrupts the light beam and removal is inferred from an uninterrupted signal. As another example, a capacitor may be used to detect the presence of an aluminum can by the detecting changed in capacitance caused by proximity to the can. This is explained in U.S. patent application Ser. No. 09/964,007, filed 26 Sep. 2001, which is hereby incorporated by reference in its entirety. Further examples of capacitive switches are disclosed in U.S. Pat. Nos. 6,225,771; 5,923,522; and 5,757,196, all of which are incorporated herein by reference in their entirety. Other sensors could also be used if needed or desired.

It should be appreciated that while the drink cooler 10 is shown, other sorts of retail displays may also be amenable to use with the present invention, such as chip and sandwich display cases, as well as non-perishable items like motor oil, and the like. Generally speaking, these are not vending machines as the payment is usually rendered elsewhere rather than at the display case. Likewise, variations in the drink cooler 10 are also contemplated, such as those drink coolers that have drink bottles suspended by the cap, rather than supported by a shelf 12.

FIG. 2 illustrates schematically some of the electronic components associated with the drink cooler 10. The sensors 22, 26 are operatively connected to a controller 30. Each sensor 22, 26 may have a unique address so that communications with the controller 30 are properly identified. The controller 30 may be a microprocessor such as an INTEL Pentium III or IV, or other appropriate data processing device such as the MOTOROLA MC68HC11F1FN. The controller 30 may further be operatively connected to one or more communicators, such as a wire communicator 32 or a wireless communicator 34. The wire communicator 32 may be an Ethernet card or the like, and may communicate over a wirebased system such as a wirebased LAN, the Public Switched Telephone Network (PSTN), or the like.

The wireless communicator 34 uses an antenna 36 or an infrared link to communicate wirelessly to a remote location. The remote location could be a portable device, such as a personal digital assistant (PDA) such as those sold by PALM, or the like (not shown). Alternatively, the remote location could be a supplier responsible for keeping the drink cooler 10 stocked. The wireless communicator 34 may communicate over a cellular system such as the Public Land Mobile Network (PLMN) or the like as needed or desired. As yet another alternative, the information may be sent through a site controller or a point of sale (POS) device located in a convenience store.

In the event that the wireless communicator 34 communicates to a portable device, the portable device may then subsequently be docked at a second remote location for transfer of the data thereto. Thus, for example, a service individual may periodically visit the display cooler, download the data into a personal digital assistant, and then travel to a corporate center where the data is uploaded to a central corporate computer for processing. Reference is made to U.S. patent application Ser. No. 10/093,735, filed 8 Mar. 2002, and entitled “Cooperative Vending Machine Data Reporting,” which is hereby incorporated by reference in its entirety, for yet another permutation of how this communication may be affected.

As explained in the previously incorporated '981 patent, additional sensors (not shown explicitly) may monitor additional data points of the drink cooler 10. These may include a power monitoring point, a temperature sensor, a door open sensor, and the like.

Further, the controller 30 may have memory 38 associated therewith. The drink cooler 10 may have a unique identifier associated therewith, which may be stored in memory 38, as well as any software needed to provide the functionality of the present invention.

As alluded to above, information collected from the sensors 22, 26 is sent to a remote location, such as remote processing center 40, which may comprise its own communicator (not shown), memory for storing information concerning inventory status of the drink coolers 10 under its supervision, and another processor for calculating and storing updated inventory, velocity, and routing information. The information collected from the sensors 22, 26 may be sent in a standard format such as the Data Exchange/Uniform Communications Standard (DEX or DEX/UCS) format, along with the unique identifier stored in memory 38. In an exemplary embodiment, the information is sent once a day, although more or less frequent submissions are also contemplated, such as once an hour, once a week, once a month or the like. The remote processing center 40 may maintain a log of received transmissions. Upon receipt of a transmission, the remote processing center 40 may extract sales information and alarm status information (if such is provided). The sales information may be used to update inventory information about a given drink cooler 10. Alarm status information may cause service personnel to be dispatched to fix the drink cooler 10.

When inventory information is received at the remote processing center 40, it is processed so as to update the current inventory status (i.e., the number of units of each item sold is subtracted from the previous inventory), and the velocity of sales is updated for each item. This in turn allows the remote processing center 40 to gauge when a product is nearing depletion such that a service call is in order to restock the product. Absent this information, the remote processing center 40 might have to use a best guess as to inventory levels, frequency of service calls, and the like, or rely on personnel collocated with the drink cooler 10 to request a service call.

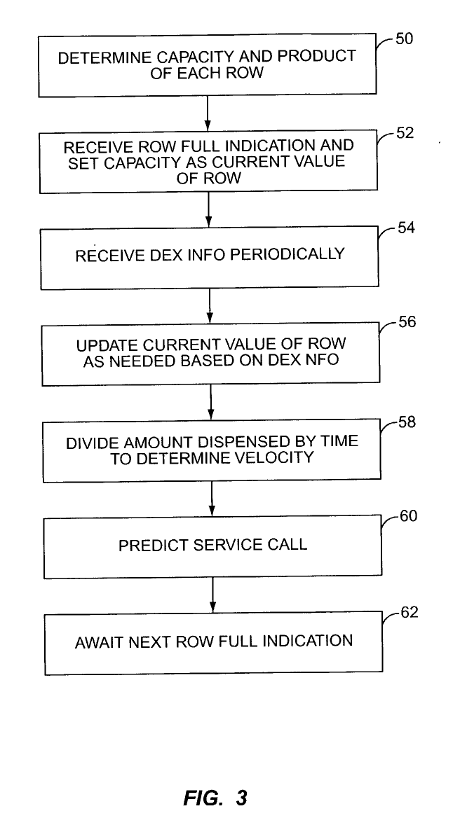

Against this backdrop of hardware and software, a method of determining a velocity with which product is sold is presented with reference to FIG. 3. In particular, the remote processing center 40 may determine a capacity and product associated with each row 14 (block 50). This may be programmed by a service technician familiar with the arrangement of the drink cooler 10, by receipt of a set of DEX information, or the like as needed or desired. The remote processing center 40 may receive a row full indication as a result of a service technician indicating such by way of a button, a report from rear sensors 26, or the like and may set the capacity as the current value of the row's inventory (block 52).

The remote processing center 40 may then receive the DEX information from the drink cooler 10 periodically (block 54). This causes the remote processing center 40 to update the current value of each row as needed based on the information in the DEX report (block 56). The amount of product dispensed divided by the time in which that product was dispensed results in a velocity (block 58) with which that row 14 is selling a particular product. This may be aggregated for multiple rows 14 selling the same product as needed or desired. Based on the velocity calculated, a service call time may be predicted (block 60). This may be done by dividing the capacity by the velocity, which results in a time value. This time value represents the time it will take the row 14 to exhaust the inventory thereof. This may be compared to a clock at the remote processing center 40 to schedule a service call. The service call may be scheduled such that it occurs before the row 14 is completely exhausted. During the service call the service technician may hit the row full indicator. Otherwise, the remote processing center 40 awaits the next row full indication (block 62). Note that the precise order of this process may be varied as needed or desired. In particular, the determination of the velocity may be an iterative process, aggregated across the entire drink cooler 10, or otherwise altered. The process illustrated is an exemplary embodiment and not intended to be limiting.

As an alternate to the predictive service calls, the sensors 22 may merely report through the DEX report that a row 14 is empty. This may trigger a service call. As a variation of this, the service call may be triggered when there are five of a product left on a given row 14, or perhaps five of a product left in the drink cooler 10. The number five is exemplary and non-limiting. Some other threshold value may be chosen instead.

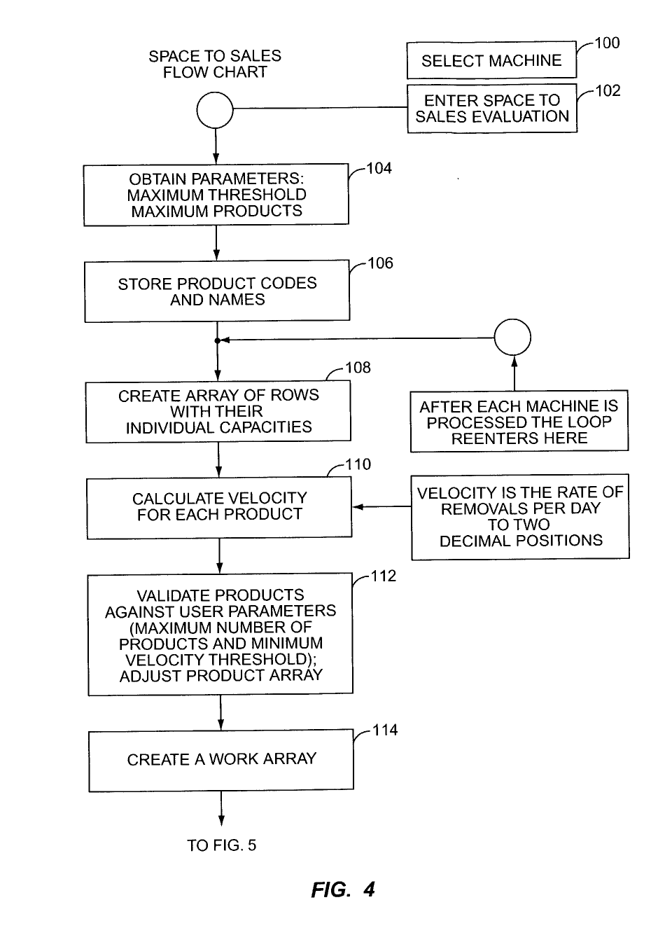

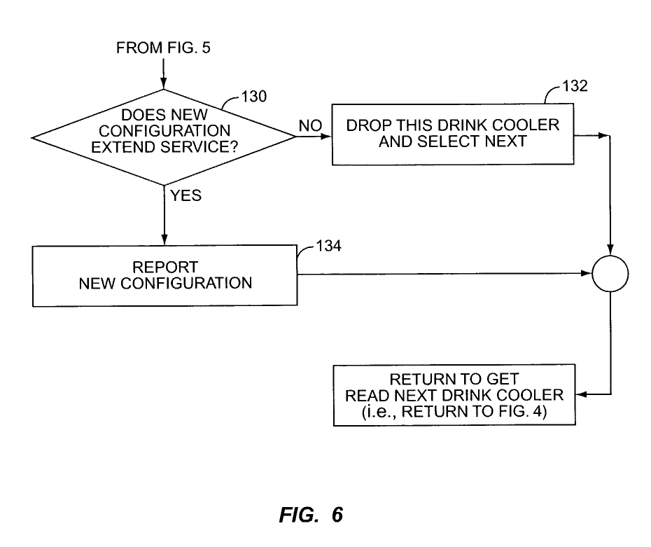

A method similar to that propounded in the '981 patent may also be followed to determine optimal space to sales configurations as well as maximize the efficiencies of service calls in conjunction therewith. This method is illustrated in FIGS. 4-6.

A drink cooler 10 is selected for analysis (block 100), said drink cooler 10 comprising at least one row 14 of drinks 16, and the process of space to sales evaluation begins (block 102). Parameters with respect to the selected drink cooler 10 are obtained and stored (block 104) at the remote processing center 40, preferably in computer-readable format, including a minimum threshold and a maximum product capacity. The maximum capacity may be calculated from the number of rows 14 in the drink cooler 10, as well as potentially the number of shelves 12. Maximum capacity may be determined by counting items removed after sensor 26 indicates a full row 14 up to the time the sensor 22 reports an empty row 14, or other techniques as desired. Product codes for drinks 16 and associated product names may also be stored (block 106) for use in report or display generation. An array of the rows 14 and shelves 12 and capacities is created (block 108). This array may further indicate the products in each row 14/shelf 12, preferably using the controller at the remote processing center 40 and accessing the computer readable formatted media.

The velocity of each product is calculated (block 110), preferably using the controller at the remote processing center 40, as the rate of sales per day, preferably to two decimal places. This may be accomplished by determining how many drinks 16 were removed from a given row in a known time period (see FIG. 3 and explanatory text). Products are validated against the user parameters (block 112), which set limits for a maximum number of products and minimum velocity, and the array is adjusted accordingly, if necessary. A work array is then created (block 114) comprising rows 14 and the drinks 16 currently assigned to those rows 14 to which two dummy rows 14 are added with zero capacity for each product.

Referring now to FIG. 4, a capacity is then calculated for each product (block 116) by allocating total capacity among products in proportion to the ratio of each product's velocity to the total velocity of the drink cooler 10. The capacity is adjusted by an iterative process, the goal of which is to minimize the value of the sum of the square of the difference between product row capacity and optimum row capacity (“FIT”). FIT is first calculated for the then-current configuration of products to rows 14 (block 118). Two rows 14 containing different products are then selected and exchanged, and a new value of FIT calculated (block 120). The new value of FIT is compared with the old value of FIT (block 122). If the value has decreased, the new configuration is used as the new “then-current” configuration (block 124). The process is repeated until the smallest value of FIT is found (block 126). If the value at block 122 has not decreased, the last setup is restored (block 128) and the process repeats.

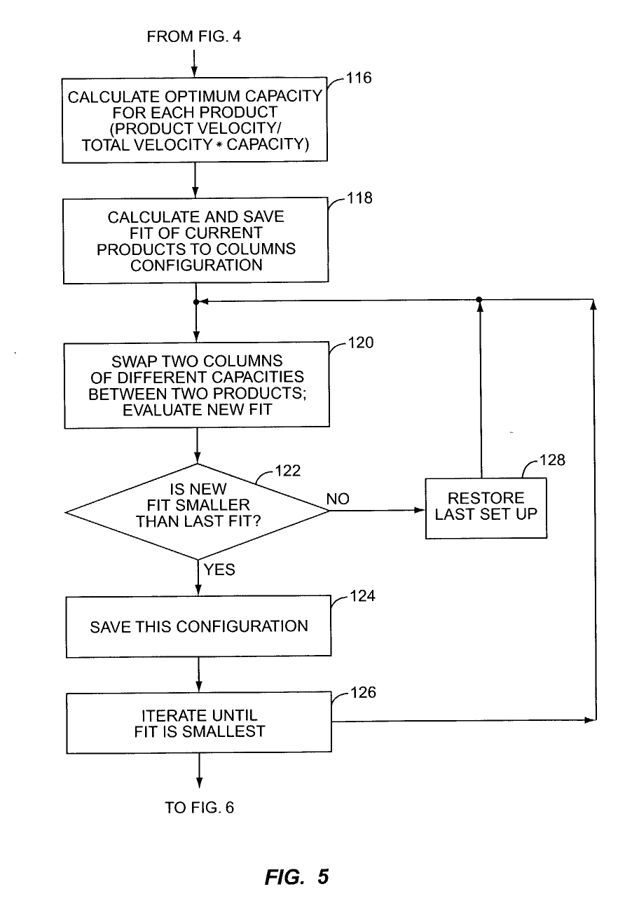

Referring to FIG. 5, a determination is next made whether the then-current configuration associated with the minimum value of FIT extends the service period (block 130); if not, the initial configuration is retained and a new drink cooler 10 is selected for evaluation (block 132). Otherwise, a recommendation is made to reconfigure the drink cooler 10 (block 134), which reconfiguration may be accomplished by service personnel during the next visit, and a new drink cooler 10 is again selected for evaluation until all the drink coolers 10 have been evaluated. Optionally, the effects of the changes on operations, such as savings in cost, may be captured and reported.

Armed with this methodology, a remote processing center 40 may calculate an optimal product configuration for a given drink cooler 10. This may comprise varying which products appear on which shelves 12, how many rows 14 within each shelf 12 are dedicated to each product, how frequently the service calls are made, and the like. Further, this information may be compared between different retail establishments to determine if a particular location is underperforming or overperforming, if needed or desired.

Those skilled in the art will recognize improvements and modifications to the preferred embodiments of the present invention. All such improvements and modifications are considered within the scope of the concepts disclosed herein and the claims that follow.

What is claimed is:

1. A retail display case, comprising:
one or more shelves for holding product;
one or more rows of product positioned on said one or more shelves;
a sensor positioned proximate a dispensing end of each of said one or more rows; and
a controller operatively connected to said sensors and collecting data therefrom relating to products removed from the rows in the course of business.

2. The retail display case of claim 1, wherein said retail display case comprises a drink cooler.

3. The retail display case of claim 1, further comprising a second array of sensors secured proximate a rear of each of said one or more rows and operatively connected to the controller for determining a maximum capacity for each of said one or more rows.

4. The retail display case of claim 1, further comprising a remote communicator.

5. The retail display case of claim 4, wherein said remote communicator comprises a wireless communicator.

6. The retail display case of claim 4, wherein said remote communicator comprises a wirebased communicator.

7. The retail display case of claim 1, wherein said controller processes information from said sensors into a DEX compatible report.

8. A method of controlling a retail display case, comprising:
installing sensors in each row from which product is sold;
collecting data from said sensors relating to each instance when a product is removed from each row; and
providing said data to a remote location for processing.

9. The method of claim 8, wherein collecting data comprises assembling the data into a DEX format.

10. The method of claim 8, further comprising installing a sensor proximate a rear point of each row for determining a maximum capacity thereof.

11. The method of claim 8, further comprising providing the data to the remote location periodically.

12. The method of claim 8, wherein providing comprises providing wirelessly.

13. The method of claim 8, wherein providing comprises providing over a wire network.

14. A system for optimizing space to sales in a retail display case, comprising a remote processing center comprising a controller adapted to receive information from a retail display case, including information relating to the number of products removed from the retail display case, and further adapted to process the information such that sales velocities and optimal space to sales configurations may be determined.

15. A retail display case system, comprising:
a retail display case, comprising:
a compartment comprising a plurality of supply rows that stores a plurality of different types of goods to be dispensed;
a CPU that counts said selected goods dispensed to generate a total number of said selected goods dispensed for each of said plurality of supply rows;
a machine identifier that identifies said retail display case; and
a transmitter that communicates a signal comprising said machine identifier and said total number of said selected goods dispensed for each of said plurality of supply rows to a remote processing center; and
said remote processing center receives said signal and calculates the capacity and velocity of each of said different types of goods based on said total number of said selected goods dispensed to determine an optimal configuration of said different types of goods in said plurality of supply columns that would maximize time efficiency between service periods for restocking of said different types of goods.

16. The system of claim 15, wherein said communication between said transmitter and said remote processing center is a one-way communication.

17. The system of claim 15, wherein said remote processing center calculates said velocity by calculating a total velocity of said retail display case by dividing said total number of said selected goods for each of said plurality of supply rows vended by time.

18. The system of claim 17, wherein said time is selected from the group consisting of a day, a week, and a month.

19. The system of claim 17, wherein calculating velocity further comprises calculating a product velocity by calculating a product velocity of each of said selected goods by dividing said total number of said selected goods for each of said plurality of supply rows vended by time.

20. The system of claim 19, wherein said remote processing center further calculates the optimal capacity for each of said plurality of supply rows by dividing each said product velocity for each of said plurality of supply rows by said total velocity and multiplying the result of such calculation times the total capacity of the retail display case.

21. The system of claim 15, wherein said remote processing center further calculates a first FIT comprising the sum of the squares of the difference between the optimal capacity of said different types of goods in each of said plurality of supply rows and an actual product capacity stored in a configuration for said retail display case in memory coupled to said remote processing unit.

22. The system of claim 21, wherein said remote processing center swaps two of said plurality of supply columns containing said different types of goods to form a new configuration of said plurality of supply rows and calculates a new FIT to determine if said new FIT is smaller than said first FIT.

23. The system of claim 22, wherein said remote processing unit stores said new configuration for said plurality of supply rows to implement during a next service period of said retail display case if said new FIT is smaller than said first FIT.

24. The system of claim 22, wherein said remote processing center calculates said new FIT in an iterative manner until the FIT for all of said plurality of supply rows has been calculated to determine an optimal configuration of said different types of goods in said plurality of supply rows to implement during a next service period of said retail display case.

25. The system of claim 15, wherein said remote processing center is adapted to predict when a service call is needed for the retail display case.

26. The system of claim 25, wherein said prediction is based on said velocity as compared with said capacity.

27. The system of claim 15, wherein said remote processing center schedules a service call when one of said rows is empty as reported by said retail display case.

28. The system of claim 15, wherein said remote processing center schedules a service call when one of said rows reaches a predetermined threshold of remaining product.
